(19) United States
(12) Patent Application Publication
(10) Pub. No.: US 2023/0278243 A1
(43) Pub. Date: Sep. 7, 2023

(54) METHOD AND APPARATUS FOR PLACEMENT OF HAIR FIBERS

(71) Applicant: Chuka Torres, Los Angeles, CA (US)

(72) Inventor: Chuka Torres, Los Angeles, CA (US)

(21) Appl. No.: 18/117,588

(22) Filed: Mar. 6, 2023

Related U.S. Application Data
(60) Provisional application No. 63/316,706, filed on Mar. 4, 2022.

(51) Int. Cl. B26B 19/06

(52) U.S. Cl. CPC B26B 19/06

(57) ABSTRACT

The trimmer/shaper can be readily gripped by a hand of a user. A neck can accept either a trimmer head or a shaper head or just the shaper head. Both heads include a stationary element and a reciprocating element which moves relative to the stationary element. On the trimmer head the two elements are cutting blades which cut hair that comes between the two cutting blades. For the shaper head, the two elements are non-cutting plates which are sufficiently blunt to substantially not cut hair, but are able to displace hair fibers by vibratory contact from a position where they are initially placed. Hair fibers are placed in a region where a hairline is to be modified. The trimmer head and/or shaper head are then selected to remove unwanted natural hair and/or hair fibers from one side of the hairline, to leave a crisp new hairline.

### CROSS-REFERENCE TO RELATED APPLICATIONS

This application claims benefit under Title 35, United States Code § 119(e) of U.S. Provisional Application No. 63/316,706 filed on Mar. 4, 2022.

### FIELD OF THE INVENTION

The following invention relates to hair trimmers. More particularly, this invention relates to hair trimmers which utilize electric power to move a reciprocating and/or vibrating blade relative to a fixed blade and which are configured to precisely shape a hairline of hair fibers and/or natural growing hair.

### BACKGROUND OF THE INVENTION

When cutting hair, one tool in the barber's arsenal to achieve a desirable appearance for the patron is to utilize hair fibers applied to the scalp of the patron to fill in areas which have an insufficient amount of natural hair. Particularly when hair is cut very short (such as less than a few millimeters), any defects in the hair of the patron, often along hairlines, can become quite noticeable. It is often desirable to obscure or eliminate any such defects.

One known prior art technique for filling in areas of thin or absent hair includes utilization of hair fibers. These hair fibers can be short pieces of actual human hair or can be synthetic fibers or a powder. Typically the fibers or powder is colored to mimic natural hair colors. Such hair fibers or powder (hereinafter collectively referred to as “fibers”) are often contained within a spray can (or other enclosure) along with some amount of compressed air or other propellant maintained under pressure (or pressurizable in some fashion). When air is allowed to blast out of the canister, entrained hair fibers also come out and can be applied to a scalp of a patron.

Due to a variety of different physical phenomena, such small hair fibers (typically less than a quarter inch in length, and most typically about 1/16 to ⅛ of an inch long, (between 1.0 and 3.0 mm long) or less in the case of powder) attach themselves to the scalp of the patron. These physical phenomena can include fine tips of the fibers penetrating the epidermis of the scalp a microscopic sufficient amount to anchor the fibers to the scalp, static attraction, adhesion due to moisture content of the scalp relative to dryness of the hair fibers and propellant, interaction of the hair fibers between each other, friction forces, and perhaps other physical phenomena which are not entirely well understood. As a result, thin and/or bald areas of the scalp of the patron can be filled in with such hair fibers. Hairspray or other compositions with adhesive properties can also optionally be utilized to hold hair fibers in place.

It is known in the prior art to utilize such hair fibers to fill in areas of the patron's scalp which need more hair. A skilled barber will then utilize a hair trimmer (also referred to as “clippers,” the terms being interchangeable herein) which are typically electric and cordless (or corded), to cut the hair as desired, and simultaneously remove any hair fibers. Typical prior art trimmers are utilized to cut the hair essentially to zero height above the scalp. The hair fibers are typically primarily not cut by the trimmers, but rather displaced from an initial position and wiped away. The result of such cutting and wiping (also called “shaping”) of natural hair and hair fibers is a clean finished hair line. However, such a procedure requires that actual powered trimmers be utilized and also can be detrimental to hair and scalp health, if used on a regular basis, for instance inducing (or amplifying) a retreating hairline phenomena.

Another known technique for applying hair fibers is to utilize a card as a form of a template while applying the hair fibers. The card is typically a thin moderately rigid piece of paper, cardboard, plastic, etc. The card is held up to a scalp area to which hair fibers are to be applied, and the hair fibers are then blown or otherwise applied to the scalp surface of an individual. Fibers which hit the card are not attached to the scalp, while fibers which miss the card adhere to the scalp. The card can then be removed. A card with a 90° corner can produce a 90° corner in the hairline which appears on the user after utilizing such a card along with hair fibers. Other templates with other shapes and angles can produce other patterns at or near a hairline of an individual.

Such a “card/template” technique can be utilized by itself. Most typically however, after such a card assisted hair fiber placement technique is performed, some amount of “trimming/wiping” occurs with a trimmer, such as the techniques described above. However, to perform these post hair fiber placement cleanup procedures, full clippers must be utilized for this trimming/wiping procedure. This requires the user to have clippers and the availability of an appropriate power source, and can be detrimental to hair health when utilized too often.

Accordingly, a need exists for a tool which can assist in wiping of hair fibers from a scalp of an individual, along with methods of use of such a tool, which can provide the benefits of utilizing a trimmer without having a tool which is merely a complete trimmer in form.

### SUMMARY OF THE INVENTION

In one embodiment according to this invention, a trimmer tool is provided which has an active mode for cutting hair and a shaper/wiper mode for hair fiber removal. As an option, the trimmer can still be “on” but cutting portions of the trimmer have been retracted sufficiently so that only vibratory wiping occurs for wiping away hair fibers. As an example, a trimmer including a stationary blade and a vibrating blade, with cutting therebetween, could include an additional replacement head with only a wiping blade. As an option, the wiping blade could be caused to vibrate relative to a body of the tool to assist in hair fiber displacement and removal. One tool would have removable/swappable heads. One trimmer head would have prior art trimmer blades thereon. The other shaper head would have one or more wiper blades. The wiper blade(s) would vibrate and/or reciprocate and optionally interact similar to blades on the trimmer head except no cutting would occur at or between the blade(s). As an option, the wiper blades could be posts that don't have sharp edges, but rather are blunt enough to not cut hair but only act to displace fibers. As an option, different types of wiper blades could be different swappable heads of the tool, for selection by a user.

As another option, a single trimmer head with a stationary blade and a vibrating blade could have at least one third “wiping” blade which can be deployed to extend slightly past the stationary and vibratory cutting blades. This third blade typically would be manually retractable and extendable and would not have cutting surfaces but only wiping surfaces. When the third blade is retracted, the cutting blades would extend most distally from a handle of the trimmer for cutting. When the third blade is extended to a most distal orientation, the tool could be utilized for wiping. Such wiping would occur while the tool is “on.” Vibration would be provided to the third blade from motion of the adjacent reciprocating blade, which third blade would not have sharp surfaces, to wipe away hair fibers vibrationally. Depending on a variety of different conditions on the surface of the scalp of the patron, the tool state might be more effective for wiping hair fibers with the wiping blade deployed or retracted. The skilled barber could rapidly switch between modes (third blade “deployed” or “retracted” or swapping heads), to either cut hair or wipe away hair fibers after hair fibers have been placed, so that a final appearance can be achieved precisely as desired.

In another embodiment, a tool could be provided which only provides a wiping function. Such a tool would beneficially have a similar size and shape (and optionally also weight) as a hair cutting trimmer, but would only provide a wiping/shaping function of hair fibers. In one embodiment, a vibrator would be contained within portions of such a tool, so that vibration would either assist in hair fiber removal or assist in providing a similar feedback “feel” to the user, or some combination of both. As another option, a reciprocating plate can move relative to a stationary plate that mimics blades of cutting clippers, but with dull posts rather than sharp teeth. Such a wiper/shaper head only tool could be similar to the trimmer described above, except that it would not have swappable heads and would not have a third mode of operation where it actually can cut hair. Rather, only hair fiber removal by wiping would occur.

Tools such as those described above can be utilized after placement of hair fibers, with or without utilization of a card or other template. Such tools as those described above could be utilized by an individual for self-grooming or could be utilized by a barber or other professional for styling purposes.

### OBJECTS OF THE INVENTION

Accordingly, a primary object of the present invention is to provide a trimmer and/or shaper as at least one part of a system for precisely shaping a hairline.

Another object of the present invention is to provide an apparatus for placement of hair fibers after they have been applied to skin of a person including removal of at least a portion of the hair fibers after initial placement.

Another object of the present invention is to provide a tool which can form a hairline made up of hair fibers and/or natural hair.

Another object to the present invention is to provide a method for removal of hair fibers after initial placement thereof.

Another object of the present invention is to provide a method for shaping a hairline which preserves health of naturally growing hair.

Another object of the present invention is to provide a method of both additive and subtractive placement of hair fibers and/or naturally growing hair, especially adjacent to a hairline.

Another object of the present invention is to provide a tool which can have multiple different heads including at least one head capable of cutting hair and at least one head capable of removing hair fibers.

Another object of the present invention is to provide a tool which includes at least one head which can remove hair fibers which have been applied to skin, but which tool does not cut naturally growing hair.

Other further objects of the present invention will become apparent from a careful reading of the included drawing figures, the claims and detailed description of the invention.

### BRIEF DESCRIPTION OF THE DRAWINGS

FIG. 1 is a rear elevation view of a trimmer/shaper tool according to this invention.

FIG. 2 is a front elevation view of that which is shown in FIG. 1.

FIG. 3 is a bottom plan view of that which is shown in FIG. 1.

FIG. 4 is a top plan view of that which is shown in FIG. 1.

FIG. 5 is a left side elevation view of that which is shown in FIG. 1, the right side being a mirror image.

FIG. 6 is a perspective view of that which is shown in FIG. 1.

FIG. 7 is a perspective view of a shaper head of that which is shown in FIG. 1, with a stationary plate and a reciprocating plate exploded away from each other.

FIG. 8 is a perspective view of the stationary plate of the shaper head of FIG. 7.

FIG. 9 is a rear view of the stationary plate of the shaper head of FIG. 7.

FIG. 10 is a detail of a portion of that which is shown in FIG. 9, taken along lines 10-10 of FIG. 9.

FIG. 11 is a side view of that which is shown in FIG. 9.

FIG. 12 is an end view of that which is shown in FIG. 9.

FIG. 13 is a perspective view of the reciprocating plate of the shaper head of FIG. 7.

FIG. 14 is a rear view of the reciprocating plate of the shaper head of FIG. 7.

FIG. 15 is a detail of a portion of that which is shown in FIG. 14, taken along lines 15-15 of FIG. 14.

FIG. 16 is a side view of a portion of that which is shown in FIG. 14.

FIG. 17 is an end view of a portion of that which is shown in FIG. 14.

FIG. 18 is a front view of a trimmer head with a stationary blade in front of a reciprocating blade for cutting hair therebetween when attached to the tool of FIG. 1.

FIGS. 19-23 are front elevation views of an individual having his hairline shaped utilizing the method and tool of this invention.

### DESCRIPTION OF THE PREFERRED EMBODIMENT

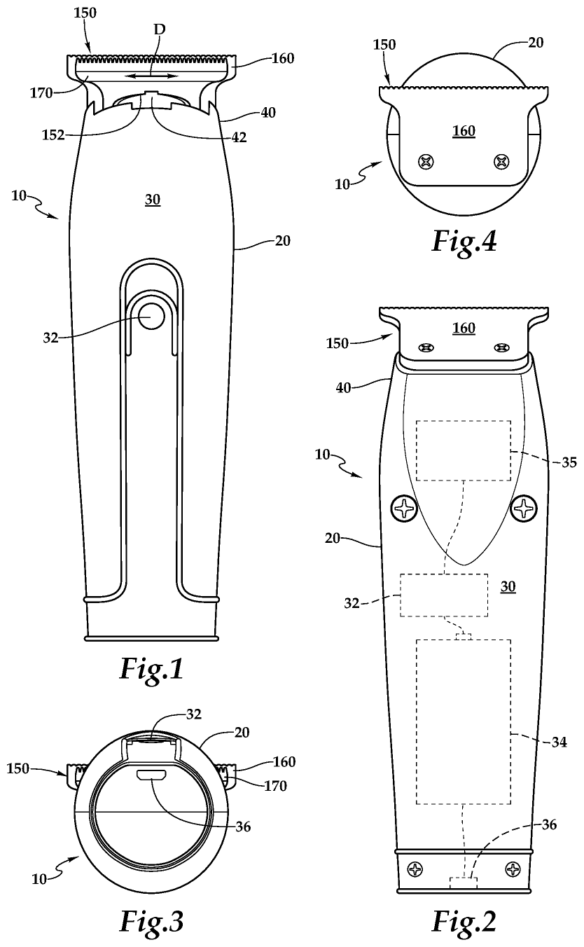

Referring to the drawings, wherein like reference numerals represent like parts throughout the various drawing figures, reference numeral 10 is directed to a trimmer/shaper (FIGS. 1-6) which can be used as part of a method to place hair fibers F (FIGS. 19-23) where desired and remove hair fibers F and natural hair H where desired, such as to precisely and accurately shape a hairline L as desired or for creation of other aesthetically desirable hair styling features.

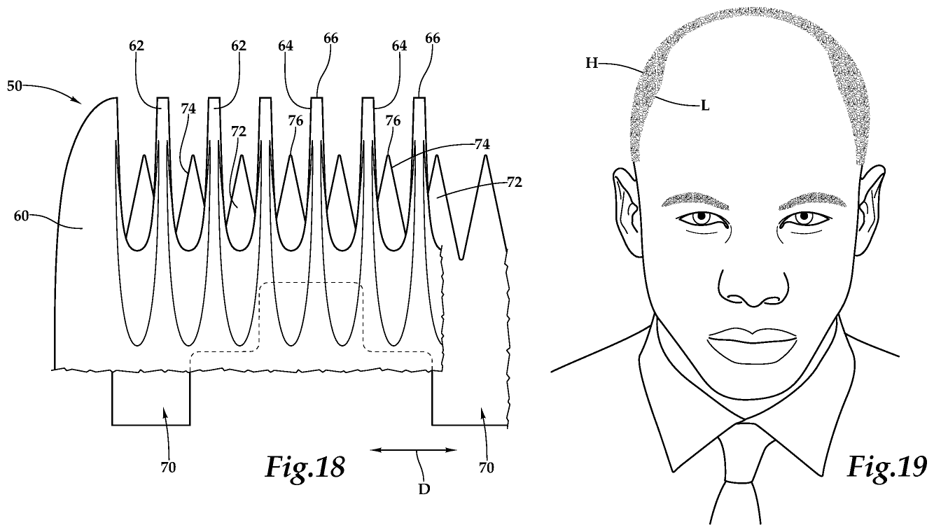

In essence, and with particular reference to FIGS. 1-6, basic details of the trimmer/shaper 10 are described according to an example embodiment. The trimmer/shaper 10 includes the body 20 surrounded on an exterior by an outer housing 30. The body 20 generally has a hand grippable shape, sized and shaped to fit within a palm of an average size human hand as well as the largest and smallest adult human hands. The outer housing 30 contains interior structures to facilitate operation of a trimmer head 50 (FIG. 18) and/or shaper head 150 attached to the body 20 through a neck 40.

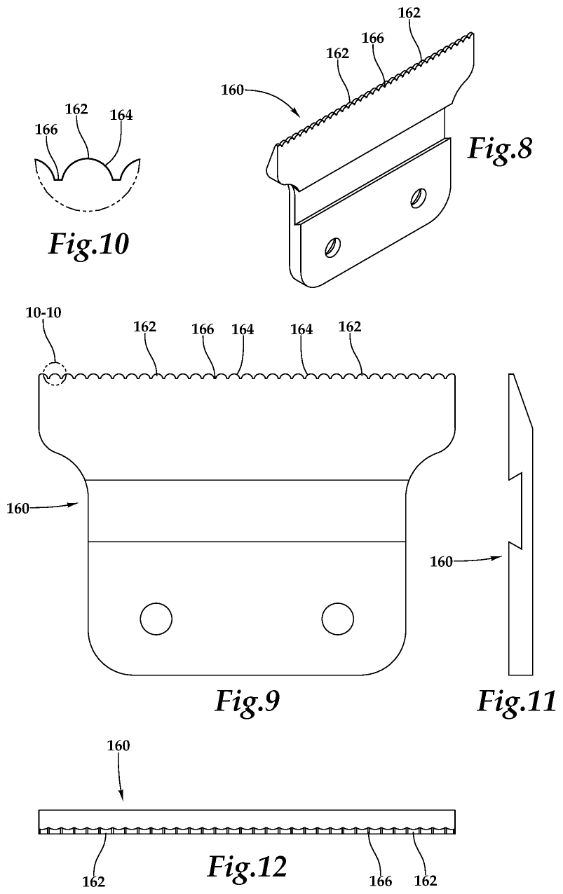

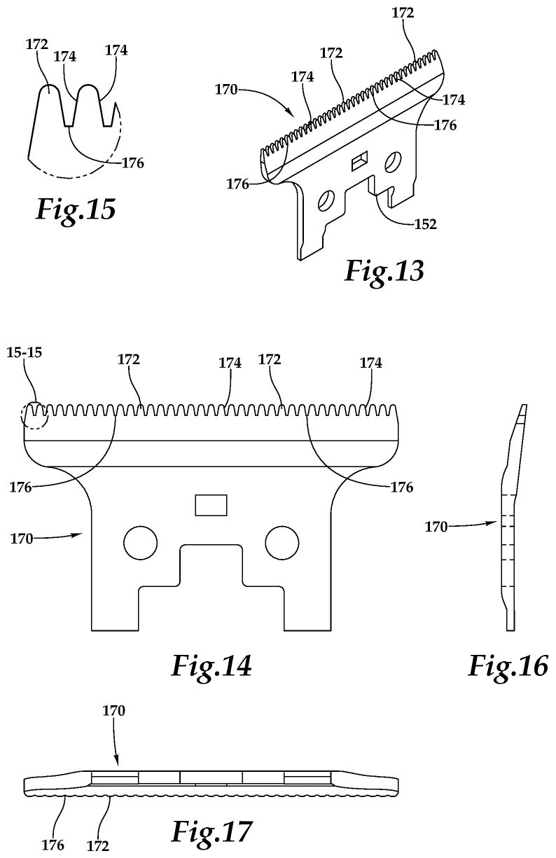

The trimmer head 50 (FIG. 18) features a stationary blade 60 and a reciprocating blade 70. The reciprocating blade 70 oscillates relative to the stationary blade 60 and includes teeth 62, 72 which move relative to each other and which are sharpened to cut hair H therebetween. The shaper head 150 (FIGS. 7-17) includes a stationary plate 160 and a reciprocating plate 170 which reciprocate adjacent to the stationary plate 160. These plates 160, 170 include posts 162, 172 which are not sharpened so they substantially cannot cut naturally growing hair H. However, they do exert a force upon hair fibers F that they come into contact with. Hair fibers F initially applied to skin have one or more adhesive forces which hold them to the skin. The shaper head 150 imparts sufficient vibratory forces upon the hair fibers F to overcome these adhesive forces and allow for the hair fibers F to be removed from their initially applied position, for ultimate removal away from skin of an individual, or at least movement away from a location where the shaper head 150 encounters the hair fibers E.

More specifically, and with particular reference to FIGS. 1-6, details of the body 20, outer housing 30 and neck 40 of the trimmer/shaper 10 are described according to this example embodiment. The body 20 typically defines the majority of the trimmer/shaper 10 by volume, and defines that portion of the trimmer/shaper 10 which is held by a user, typically by hand of a user and wielded to cut and/or shape hair H and/or hair fibers F upon an individual (which could be the user or a second individual, such as a patron of the user).

In this particular embodiment, the body 20 has its geometry defined primarily by an outer housing 30. The outer housing 30 in this embodiment is generally cylindrical in form but tapering somewhat at ends, and generally extending from a proximal end to a distal end. A distal end of the body 20 supports a neck 42 and a trimmer head 50 (FIG. 18) and/or shaper head 150. An interior of the body 20 is generally configured to include components which cause the trimmer head 50 and/or shaper head 150 to exhibit reciprocating and/or vibratory motion for cutting and/or shaping action. In particular, these components typically include a power source, such as a battery or wiring leading to a cord which can plug into a receptacle (or both). This battery or other power supply is coupled to a motor. The motor is configured generally in a typical prior art fashion that is utilized for trimmers to cause a drive output 42 to exhibit a reciprocating/oscillating motion. Typically, this oscillating motion is a lateral repeating side-to-side motion.

The outer housing 30 contains these interior components within the body 20 and provides an outer surface configured to be readily gripped by a hand of a user. This housing 30 in this example embodiment is generally cylindrical and has a hand grippable size to accommodate easy gripping by a hand of a user. In particular, the outer housing 30 is sized so that an average size hand of a human user can readily grip the outer housing 30 in a palm thereof. Example dimensions include a length between the proximal end and the distal end of about 4 inches and a diameter for the general cylindrical form of the outer housing 30 of about 1.5 inches.

While these dimensions are provided as an illustration, a length of the outer housing 30 could be as short as 2 inches or even somewhat shorter in some embodiments. This length of the outer housing 30 could be as long as 6 inches or even somewhat longer in some embodiments. The diameter of the outer housing 30 could be as small as 1 inch or a little smaller in diameter, or could be as large as 2 inches or somewhat larger in some embodiments. While the housing 30 in this example is mostly cylindrical, alternative embodiments could have a more oval cross-section, such as with a width of about 2 inches and a thickness of about 1 inch. This cross-section could be more rectangular, such as rectangular with rounded corners, or could be more elliptical, and still function according to this invention.

Materials forming the outer housing 30 are preferably selected so that a user can firmly grip the outer housing 30. A weight of the trimmer/shaper 10 is preferably sufficiently low that a user can wield the trimmer/shaper 10 for long periods of time without fatigue. As an example, a weight of less than 1 pound is considered to be optimal, with a weight less than 2 pounds being at least moderately acceptable. If a cord is attached to the outer housing 30, it is typically attached at the proximal end of the housing and attached in a removable fashion through the port 36.

In one embodiment, the trimmer/shaper tool 10 can be utilized either wirelessly off of an internal battery 34 supplying power or can be plugged in and operated utilizing electric power, at least partially provided from utility service. As an option, the battery 34 could be dispensed with and the tool 10 could be utilized merely with utility power. As another option, the cord could be provided only to recharge the battery 34 and not supply power directly to the motor 35 from utility electrical service. A power switch 32 is also typically provided upon the outer housing 30. This power switch 32 is toggled by a user, such as by manual forces applied thereto, to turn the tool 10 on and off. When on, the motor 35 within the body 20 is in operation and when in the off position, the motor 35 ceases operation.

The neck 40 includes a drive output 42 coupled to the motor 35 within the outer housing 30 of the body 20. This drive output 42 oscillates back-and-forth through operation of the motor 35. For instance a transmission can convert rotational motion from an output shaft of the motor 35 into oscillating motion. The neck 40 also preferably includes appropriate coupling structures, which facilitate removable attachment of either the trimmer head 50 to the neck 40 or the shaper head 150 to the neck 40. Both the trimmer head 50 and shaper head 150 include a drive attachment, such as the drive attachment 152 which can engage with the drive output 42 of the neck 40, so that vibrating structures associated with the trimmer head 50 (FIG. 18) and/or the shaper head 150 can be caused to undergo vibrating motion responsive to motion of the drive output of the neck 40 of the tool 10.

With particular reference to FIG. 18, details of the trimmer head 50 are described, according to this example embodiment. The trimmer head 50 is removably attachable to the neck 40 of the trimmer/shaper tool so that the trimmer head 50 can be swapped with the shaper head 150 and so that the tool 10 can provide the functionality desired by the user for the tool 10. The trimmer head 50 operates generally similar to the manner of operation of many other prior art trimmers, as described herein below.

The trimmer head 50 includes a stationary blade 60 and reciprocating blade (also sometimes called a vibrating blade) 70. The stationary blade 60 is configured to attach through the neck 40 to the body 20 of the trimmer/shaper tool 10 in a generally fixed manner. The stationary blade 60 has a thin elongate form extending away from the distal end of the body 20 of the trimmer/shaper tool 10. This stationary blade 60 terminates at fixed teeth 62. Lateral edges 64 of the fixed teeth 62 extend to tips 66 and with the lateral edges 64 sharpened.

The reciprocating blade 70 has a generally planar form which is parallel with and adjacent to the stationary blade 60. The reciprocating blade 70 includes moving teeth 72 with side edges 74 which extend to points 76. The side edges 74 are also sharpened, similar to the way that the lateral edges 64 are sharpened.

The reciprocating blade 70 is configured so that it attaches to the drive attachment of the trimmer head 50. In this way, the reciprocating blade 70 moves when the motor 35 of the trimmer/shaper 10 is in operation. The stationary blade 60 remains fixed. To facilitate cutting of hair H adjacent the trimmer head 50 the reciprocating blade 70 is directly adjacent to the stationary blade 60. Hair H extending between the lateral edges 64 of the fixed teeth 62 of the stationary blade 60 (also called a stationary element) and the side edges 74 of the moving teeth 72 of the reciprocating blade 70 (also called a reciprocating element) are cut. In particular, as moving teeth 72 of the reciprocating blade 70 interact with the fixed teeth 62 of the stationary blade 60, hair H trapped therebetween is cut at this point. If the tips 66 of the stationary blade 60 and points 76 of the vibrating blade 70 extend a similar distance away from the distal end of the body 20 of the trimmer/shaper 10, hair H can be essentially cut at the surface of the skin.

Typically, the tips 66 of the fixed teeth 62 of the stationary blade 60 extend slightly further and the points 76 of the moving teeth 72 of the vibrating blade 70, so that the relative motion of the teeth 62, 72 avoids cutting the skin, but is closer to the same extension distance than that shown in FIG. 18 to facilitate full cutting and removal of growing hair H. More skilled operators can effectively wield the trimmer/shaper tool 10 with a smaller differential spacing between the points 76 of the vibrating blade 70 and the tips 66 of the stationary blade 60. Typically these points 76 and tips 66 are sharp points so that the lateral edges 64 extend all the way to the tips 66 and the side edges 74 extend all the way to the points 76 for cutting all the way up to near the tips 66 and full to the points 76.

With a particular reference to FIGS. 7-17, details of the shaper head 150 are described, according to this example embodiment. The shaper head 150 can be placed onto the neck 40 of the trimmer/shaper 10 in the same way that the trimmer head 50 is so attached. First the trimmer head 50 would be removed and then the shaper head 150 can be attached to the neck 40. The stationary plate 160 of the shaper head 150 attaches to the body 20 of the trimmer/shaper tool 10 in a manner keeping the stationary plate 160 generally stationary relative to the body 20. The stationary plate 160 (also called a stationary element) includes fixed posts 162 spaced apart by gaps 166. The fixed posts 162 preferably are rounded in form and do not come to a sharp point. Also, these fixed posts 162 are not sharpened along lateral edges 164 thereof, but rather are left blunt.

A reciprocating plate (also called a vibrating plate) 170 is also associated with the shaper head 150 and is attached to the drive attachment 152 to the drive output 42 of the neck 40. This reciprocating plate 170 (also called a reciprocating element) thus reciprocates and/or vibrates when the motor 35 of the trimmer/shaper tool 10 is in operation. The reciprocating plate 170 is parallel with the stationary plate 160 and directly adjacent thereto. The reciprocating plate 170 features moving posts 172 with spaces 176 therebetween. The moving posts 172 preferably do not come to a sharp point, but rather are blunt and preferably semi-circular in form. Spaces 176 are provided between these moving posts 172. The moving posts 172 have edges 174 which are not sharpened. The reciprocating plate 170 is directly adjacent to the stationary plate 160 for reciprocating and/or vibratory motion therebetween. However, because the posts 162, 172 do not come to sharp points and do not have sharp lateral edges, they do not substantially cut hair adjacent thereto. Rather, hair H which is contacted by the posts 162, 172 is merely contacted, but not cut.

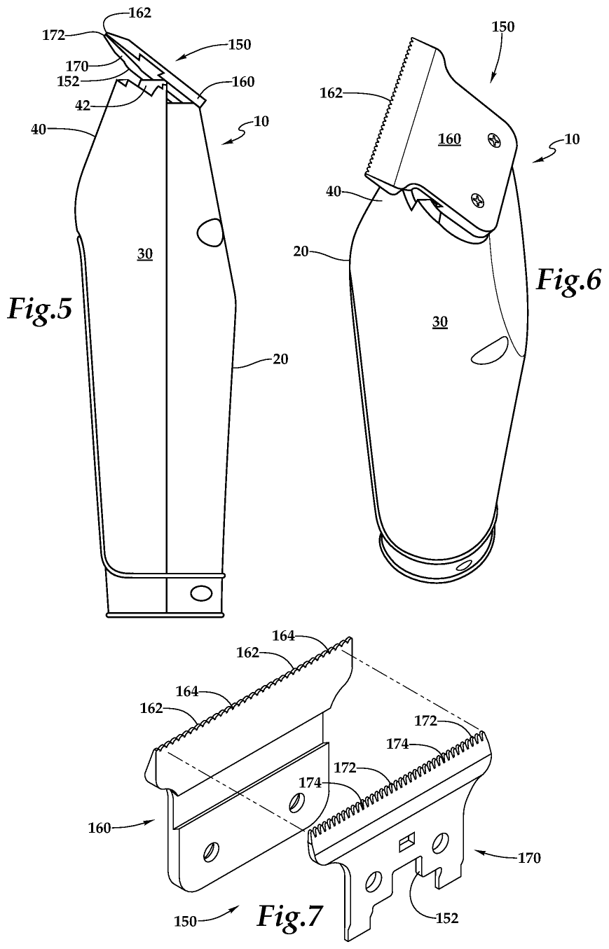

Typically, the posts 172 extend a similar distance as the posts 162, as shown in FIG. 5. While extension of the reciprocating plate 170 could be adjustable, in a most straightforward embodiment the reciprocating plate 170 is not adjustable and terminates at tips of the moving posts 172 aligned with tips of the stationary posts 162. As an option, at least factory adjustability could be provided, or optionally also user adjustability. In one embodiment, the tool 10 only has the shaper head 150, permanently attached to the body 20 as a typical option. The tool 10 is then optimized for use by unskilled users, such as use on one's own head.

In contrast, hair fibers F which encounter the vibratory/reciprocating action of the posts 162, 172 of the reciprocating plate 170 and stationary plate 160 are dislodged from attachment to skin and either fall away from the skin, or are moved due to motion imparted on the hair fibers F by the shaper head 150. In effect, the shaper head 150 can exert a wiping force on the hair fibers F and cause the hair fibers F to be readily wiped from a first location to a second location (if not entirely removed from the skin). The hair fibers F can then be further removed, such as with a small piece of damp paper towel, or wet cloth or some other hair fiber removal tool. The vibratory and/or reciprocating motion of the shaper head 150 is believed to overcome attractive forces between the hair fibers F and the skin to facilitate removal from a hairline L or other displacement.

Hair fibers F attach to skin (and potentially also to natural growing hair H) through a variety of different attractive forces, depending on the nature of the hair fibers F and other hair fiber F placement techniques. These attractive forces are believed to include but not be limited to static attraction, slight attachment associated with sharp ends of the hair fibers engaging at least somewhat with the epidermis of the skin, application of hairspray or other constituents, which cause the hair fibers F to adhere at least somewhat, as well as potentially other attractive forces. It has been discovered through this invention that these attractive forces of hair fibers F to skin (and natural hair H) can be sufficiently disrupted to allow the hair fibers F to be moved merely due to the vibratory forces of a trimmer head 50 and/or shaper head 150 of a trimmer/shaper tool 10.

While a prior art hair trimmer tool can be utilized to move hair fibers F, it is often desirable to rather frequently place and remove hair fibers F, such as to maintain a crisp hairline L. However, such frequent use on both hair fibers F and also upon natural hair H in at least some instances, is believed to cause or accelerate hair loss, and effectively cause a receding natural hairline L. By providing a trimmer/shaper tool which has both a trimmer head 50 and with the shaper head 150, and with the shaper head 150 not cutting hair H, this shaper head 150 can be used liberally and often without concern for damaging natural hair H or progressing receding of a natural hairline L. The trimmer head 50 can thus be utilized merely where needed to cut growing hair H. In making the trimmer head 50 and shaper head 150 readily swappable on a single trimmer/shaper tool 10, a user can conveniently select the optimal head 50, 150 for the particular circumstances and achieve an optimal result, both aesthetically and for the health of natural hair H of the individual. Furthermore, a tool 10 with only the shaper head 150 can be used regularly, even daily, in a home use manner between visits to a barber. A user can thus safely maintain the user's hairline L in a safe manner without cutting any hair H.

In use in operation, and with reference to FIGS. 19-23 and utilizing the tool 10 according to this example embodiment, one method is described for providing a crisp hairline L for an individual which has either no natural hair H or some natural hair H, but less than a desired amount, at least in a region where a hairline L is to be established or made more sharp and crisp.

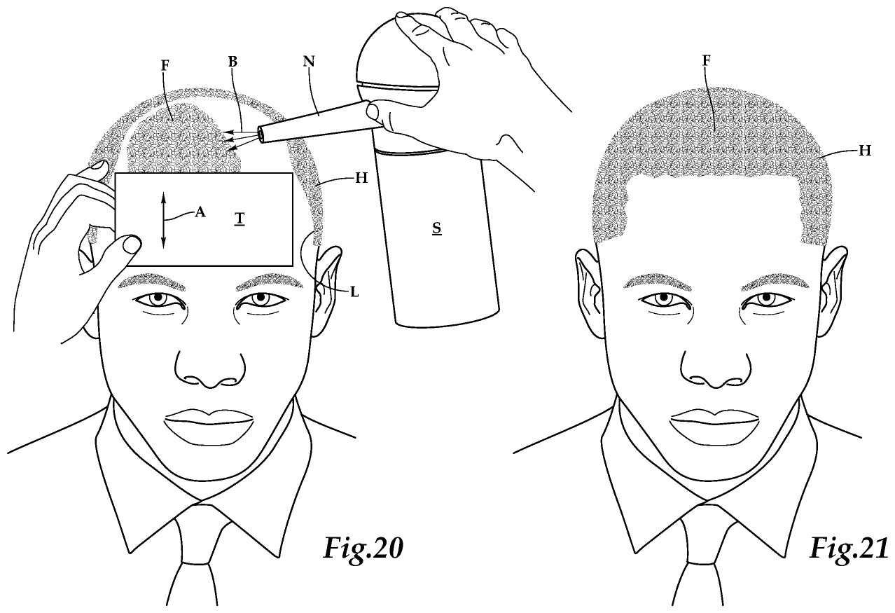

In the first step, hair fibers F are applied especially in areas where natural hair H is thin or absent, but is desired to be located. FIG. 19 shows an individual before application of hair fibers F in one example. Typically, an applicator S contains hair fibers F within a container which can aerosolize the hair fibers F somewhat and spray them onto hair H or other locations of an individual (along arrow B of FIG. 20). In this first step, it may be desirable (but is not needed) to utilize a card or other template, positioned (along arrow A for instance) to cover areas of skin which are preferred to be on a hair-free side of the hairline L, so that hair fibers F are primarily placed only on the hair side of the desired hairline L. Generally, the tool 10 replaces the need for such a card to be used. After the first step, typically hair fibers F have been placed to establish a first rough outline of a desired hairline L (see FIG. 21), with the hair fibers F typically encroaching too far onto an ultimately desired hair-free side of the hairline L, and without desired “crispness.”

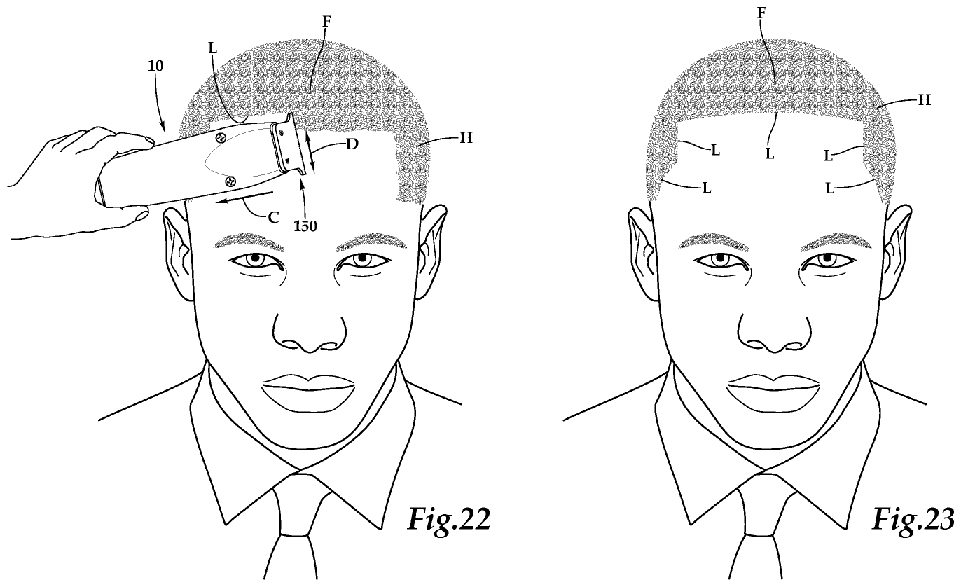

In a second step, the tool 10 is fitted with the shaper head 150 upon the neck 40 of the trimmer/shaper 10. The tool 10 is then powered on, causing the stationary plate 160 and reciprocating plate 170 to move (along arrow D of FIGS. 1 and 22) relative to each other upon the shaper head 150. The shaper head 150 is then brought near the hairline L. The shaper head 10 can be placed along a desired location for the hairline L, and then moved laterally away from the hairline L and toward a hair-free side of the hairline L. The hair fibers F are “wiped” away from the hairline L, somewhat in a “raking” motion is a series of steps away from the hairline L that is being crisply established. The hair fibers F will either fall away from the skin through this vibratory action or are moved sufficiently that they can then be wiped off of the skin of the individual, such as utilizing a small swatch of damp cloth to wipe away the hair fibers E The user continues to skillfully wield the shaper head 150 of the trimmer/shaper tool 10 until the hairline L has been fully established as desired (see FIG. 23). The tool 10 can also be used in a similar manner on hair coloring and/or filling powders. Also, hair dye and skin makeup can be disrupted and removed by the tool 10 in at least some instances, to obtain a desired aesthetic appearance.

For many individuals, some natural hair might be on the hair-free side of the hairline L. The shaper head 150 is then removed from the neck 40 (typically after the tool 10 has been powered off). The trimmer head 50 can then be placed upon the neck 40 of the trimmer/shaper tool 10 and the tool 10 turned on. The trimmer head 50 (FIG. 18) can then be utilized to cut any hair on the hair-free side of the hairline L. If desired, a final step can be to apply hairspray or other fixing agents to help to fix the hair fibers F more fully to skin and adjacent hair H of the individual. As a result, the individual is provided with the appearance of a full head of hair and with sharp and crisp hairlines L, as well as freedom from bald spots, thin areas and any other hair anomalies which might be considered to be defects.

In other embodiments, a similar technique can be utilized with either the shaper head 150 and/or the trimmer head 50 to provide decorative contours either to a hairline L or to places on the individual inboard of any hairlines, such as decorative aesthetic features. Generally, the shaper head 150 is first utilized in areas where at least some absence of hair H exists, and after hair fibers F that have been applied. Then, the heads 150, 50 would be swapped for each other and a trimmer head 50 would be used to cut any natural hairs H which were not cut by the shaper head 150. Hairlines of the head and neck, including the beard, can be effectively trimmed and shaped utilizing the tool 10 of this invention and the methodologies described above herein.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A tool for removal of hair fibers from a scalp of an individual, the tool comprising in combination:
a hand held body;
a head at a distal end of said body;
said head including a reciprocating element for displacing hair fibers with which said head comes into contact; and
said head having at least one mode of operation where said head is free from cutting hair of the individual.

2. The tool of claim 1 wherein, in at least one mode of operation, said reciprocating element reciprocates relative to said body.

3. The tool of claim 2 wherein said reciprocating element is coupled to a motor within said body.

4. The tool of claim 2 wherein said reciprocating element reciprocates relative to a stationary element that is adjacent to said reciprocating element.

5. The tool of claim 4 wherein said reciprocating element is oriented parallel to said stationary element, and with each of said reciprocating element and said stationary element including posts at distal portions thereof, said posts extending to a common location for tips of said stationary element and said reciprocating element.

6. The tool of claim 2 wherein in at least one mode of operation said head has a cutting element that moves relative to a stationary element to cut hair coming between teeth thereof, said teeth extending further distally from said body than other portions of the tool.

7. The tool of claim 3 wherein at least two swappable heads are provided, each removably attachable to said body, at least one of said swappable heads having a stationary blade as said stationary element and a reciprocating blade as said reciprocating element, which blades interact to cut hair at said blades.

8. The tool of claim 7 wherein at least one of said swappable heads includes said reciprocating element reciprocating relative to a stationary element that is adjacent to said reciprocating element.

9. The tool of claim 8 wherein said reciprocating element is oriented parallel to said stationary element, and with each of said reciprocating element and said stationary element including posts at distal portions thereof.

10. The tool of claim 7 wherein at least one of said at least two swappable heads includes a vibrating head which vibrates relative to said body.

11. A method for styling hair fibers, including the steps of:
placing hair fibers in an area of a scalp of an individual to be styled;
utilizing a tool having at least one mode of operation for displacing the hair fibers placed during said placing step; and
said utilizing step including moving the tool adjacent to areas of a scalp of a user to have hair fibers removed.

12. The method of claim 11 wherein said utilizing step includes moving a distal end of the tool adjacent to a hairline to be established.

13. The method of claim 12 wherein said at least one mode of operation of said utilizing step is a shaping mode for said utilizing step when only hair fibers are being removed.

14. The method of claim 12 wherein said utilizing step includes a second mode of operation which is a cutting mode for said utilizing step, when only growing hair is being cut and removed.

15. The method of claim 14 wherein said cutting mode is used for said utilizing step to simultaneously remove both hair fibers and growing hair.

16. The method of claim 11 wherein the tool includes a trimmer head and a shaper head, both the trimmer head and the shaper head removably attachable to a body of the tool, the body supporting an output of a motor, which output is attachable to both the trimmer head or the shaper head to impart motion upon the trimmer head or the shaper head.

17. The method of claim 16 wherein the trimmer head includes a stationary blade and a reciprocating blade, each blade having teeth thereon to cut hair encountered by the teeth of the blades.

18. The method of claim 16 wherein the shaper head has a similar size as the trimmer head so that similar tool movements of the user have similar removal results for the shaper tool removing hair fibers as the trimmer tool removing growing hair.

19. The method of claim 11 wherein said tool includes a shaper head with a stationary plate and a moving plate, the moving plate having posts which impact and displace the hair fibers encountered thereby, without cutting.

20. The method of claim 19 wherein the shaper head includes the posts extending to tips aligned with tips of posts of the stationary plate.
